(19) United States
(12) Patent Application Publication
(10) Pub. No.: US 2025/0122859 A1
(43) Pub. Date: Apr. 17, 2025

(54) MULTI-STAGE BUFFER HYDRAULIC CYLINDER FOR WAVE-ENERGY POWER GENERATION APPARATUS AND MULTI-STAGE BUFFER HYDRAULIC CONTROL METHOD

(71) Applicant: GUANGZHOU INSTITUTE OF ENERGY CONVERSION, CHINESE ACADEMY OF SCIENCES, Guangzhou (CN)

(72) Inventors: Yin YE, Guangzhou (CN); Kunlin WANG, Guangzhou (CN); Songwei SHENG, Guangzhou (CN); Zhenpeng WANG, Guangzhou (CN)

(73) Assignee: GUANGZHOU INSTITUTE OF ENERGY CONVERSION, CHINESE ACADEMY OF SCIENCES, Guangzhou (CN)

(21) Appl. No.: 18/682,118

(22) PCT Filed: Apr. 27, 2023
(86) PCT No.: PCT/CN2023/091032

§ 371 Date: Feb. 8, 2024

(30) Foreign Application Priority Data
Apr. 29, 2022 (CN) 202210474740.3

(51) Int. Cl. F03B 13/14; E02B 9/08; F15B 1/04; F15B 15/14

(52) U.S. Cl. CPC F03B 13/14; E02B 9/08; F15B 1/04; F15B 15/1457; F05B 2260/406

(57) ABSTRACT

A multi-stage buffer hydraulic cylinder for a wave-energy power generation apparatus and a multi-stage buffer hydraulic control method are provided. A built-in fixed rod is arranged inside a cylinder barrel of a hydraulic cylinder and nested in a piston rod, and a fixed-rod inner cavity and a piston-rod inner cavity are taken as high-pressure working cavities, such that the diameter of the piston rod can be increased while the effective work area is reduced. Front and rear end covers of the hydraulic cylinder each are provided with a buffer spring for buffering the strike caused by the excessive stroke of the piston rod under the extreme wave condition, and the hydraulic cylinder may be buffered under the condition of heavy waves by setting the stiffness of the spring, such that a main piston does not strike the front and rear end covers.

### CROSS REFERENCE TO THE RELATED APPLICATIONS

This application is the national phase entry of International Application No. PCT/CN2023/091032, filed on Apr. 27, 2023, which is based upon and claims priority to Chinese Patent Application No. 202210474740.3, filed on Apr. 29, 2022, the entire contents of which are incorporated herein by reference.

### TECHNICAL FIELD

The present invention relates to the technical fields of wave-energy hydraulic power generation and fluid pressure actuators, and in particular, to a multi-stage buffer hydraulic cylinder for a wave-energy power generation apparatus and a multi-stage buffer hydraulic control method.

### BACKGROUND

Wave energy, as clean and pollution-free marine renewable energy, has the advantages of abundant reserves, high energy density and the like. The technology for utilizing the wave energy has become an active research and development hotspot in various coastal countries around the world. Waves have the characteristics of reciprocation, low frequency and large output, and a hydraulic system with an energy accumulation process can well buffer the impacts resulting from these characteristics of the waves, allowing stable final energy output to meet the requirements of grid connection. Therefore, a hydraulic energy conversion system is mainly selected for energy conversion for current wave energy apparatuses.

A hydraulic cylinder in a hydraulic wave energy conversion system is a power component for converting wave energy into hydraulic energy, while a traditional hydraulic cylinder, on the contrary, mainly functions as an actuating element to convert mechanical energy into hydraulic energy. Furthermore, the hydraulic cylinder of a wave energy apparatus works in the seawater (or seawater vapor) for a long time, under harsh working conditions. Therefore, the hydraulic cylinder is a component that is more prone to failure in a wave-energy power generation apparatus. At present, there are two main modes in which the hydraulic cylinder does work on the wave energy apparatus. By taking the dual floating-body point-absorption type work as an example, as shown in FIG. 1, the wave-absorbing floating body moves upward relative to the main body under the action of waves to do work, and downward movement mainly depends on the gravity of the wave-absorbing floating body itself. Generally, the work is done by utilizing wave forces only, that is, the energy of the work resulting from the upward movement of the floating body is utilized.

In the first mode of work, the hydraulic cylinders are installed below the wave-absorbing floating body and placed in the seawater; one end of each of the hydraulic cylinders is connected to the wave-absorbing floating body, and the other end thereof is connected to a position at a lower part of a main body; as shown in FIG. 1, when the wave-absorbing floating body moves upward under the action of waves, a rod of the hydraulic cylinder is pulled upward under the drive of the wave-absorbing floating body, which belongs to doing work by pulling the cylinder, since a rod-containing cavity of the hydraulic cylinder is filled with high-pressure hydraulic oil. In such a mode of work, the effective work area of the hydraulic cylinder is S₁−S₂, with S₁ representing the area of a piston and S₂ representing the area of a piston rod, and the output force is F=p×(S₁−S₂),with p representing the pressure of an energy accumulator. The advantage of doing work by pulling the cylinder is that the hydraulic cylinder does work in a pulled condition for a long time, such that there is no problem with rod compression stability (which is present only when the hydraulic rod is compressed), and the piston rod of the hydraulic cylinder is not prone to mechanical damage. However, there are more disadvantages that are difficult to solve at present, mainly including: (1) serious corrosion of the piston rod due to the fact that the hydraulic cylinder is installed underwater; (2) comparably serious contamination due to the fact that a large number of marine organisms attached to the surface of the piston rod may easily damage a sealing ring of the hydraulic cylinder under the frequent movement of the piston rod; (3) low convenience of routine maintenance and overhaul due to the fact that the hydraulic cylinder is installed underwater; (4) greater impact on the environment once the sealing ring of the hydraulic cylinder fails to leak all the hydraulic oil into the seawater; (5) serious damage to the system once the sealing ring of the hydraulic cylinder fails to allow seawater to enter the entire hydraulic system; and (6) damage arising from stroke limit in the case of heavy waves, since the hydraulic cylinder may strike the hydraulic cylinder barrel when the movement amplitude of the piston rod exceeds the stroke limit of the hydraulic cylinder. These six disadvantages make it difficult to make large-scale use of the wave energy apparatus with the hydraulic cylinder being pulled to do work, at present.

In the second mode of work, the hydraulic cylinders are installed above the floating body and placed on the sea. As shown in FIG. 2, the floating body moves upward to do work and has one end connected to the wave-absorbing floating body and the other end connected to the top of the main body. When the floating body moves upward, the hydraulic cylinder is compressed to do work, which belongs to doing work by compressing the cylinder since a rodless cavity of the hydraulic cylinder is filled with hydraulic oil. In such a mode of work, the effective work area of the hydraulic cylinder is S₁, i.e., the cross-sectional area of the piston, and the output force is F=p×S₁. With the same wave force and the same energy accumulator pressure, the hydraulic cylinder needs to be made thinner, otherwise, the hydraulic cylinder cannot be driven to move under the same wave force. Such a mode of work ameliorates disadvantages (2), (3), (4) and (5) of the mode of work done by pulling the cylinder, and thus has been used in most of the hydraulic cylinders at present. In addition, the mode of work done by compressing the cylinder also leads to other problems, mainly including: (1) difficulty in designing the diameter of the piston rod of the hydraulic cylinder, since tool thin design may lead to poorer rod compression stability (which is also related to the diameter of the piston rod) of the hydraulic cylinder, and bending and thus failure of the rod, and too thick design may lead to larger work area and extremely low work efficiency since the hydraulic cylinder cannot be pushed to do work under small waves; (2) comparably serious corrosion of the rod surface since the hydraulic cylinder is disposed in the seawater vapor, which may easily lead to sealing ring failure to result in pressure loss of the hydraulic cylinder; and (3) problems caused by stroke limit regardless of the work done by pulling or compressing the cylinder, in either case it is necessary to buffer the oil cylinder in the case of stroke limit so as to prevent the oil cylinder from moving beyond the stroke limit. Therefore, in order to allow the hydraulic cylinder of the wave energy apparatus to work stably and reliably, it is very important to propose a reasonable hydraulic cylinder design method to effectively solve the above problems.

### SUMMARY

In view of the defects in the prior art, the present invention provides a multi-stage buffer hydraulic cylinder for a wave-energy power generation apparatus and a multi-stage buffer hydraulic control method, in which a hollow rod is arranged inside a driving hydraulic cylinder to greatly reduce the possibility of oil leakage during operating of the hydraulic cylinder, which solves the problem with rod compression stability of the hydraulic cylinder in the case of doing work by compressing the cylinder and improves the reliability and stability of the wave-energy hydraulic cylinder.

To achieve the object above, the present invention employs the following technical solution.

A multi-stage buffer hydraulic cylinder for a wave-energy power generation apparatus is used to be connected to the wave-energy power generation apparatus, which includes a main body and a wave-absorbing floating body, and the multi-stage buffer hydraulic cylinder includes:
a cylinder barrel provided with a rear end cover and a front end cover at both ends, the cylinder barrel being connected to the main body;
a built-in fixed rod coaxially arranged in the cylinder barrel, the built-in fixed rod having a hollow cavity, and a right end of the built-in fixed rod extending to the front end cover and being installed with an auxiliary piston; and
a piston rod coaxially sleeving the built-in fixed rod, the piston rod having a hollow cavity, a left end of the piston rod being installed with a main piston, a right end of the piston rod being connected to the wave-absorbing floating body, and the cylinder barrel, the piston rod and the built-in fixed rod forming a multi-stage cylinder, wherein
the hollow cavity of the built-in fixed rod is a fixed-rod inner cavity, and a left end of the fixed-rod inner cavity is communicated with a main oil port; a cavity defined by an outer wall of the built-in fixed rod, an inner wall of the piston rod, the main piston and the auxiliary piston is a sealed cavity;
the hollow cavity of the piston rod excluding a portion forming the sealed cavity is a piston-rod inner cavity; a cavity defined by an inner wall of the cylinder barrel, the rear end cover, the outer wall of the built-in fixed rod and the main piston is a main cavity, which is communicated with a rear oil port; a cavity defined by the inner wall of the cylinder barrel, the front end cover, an outer wall of the piston rod and the main piston is a rod-containing cavity, which is communicated with a front oil port; the fixed-rod inner cavity is communicated with the piston-rod inner cavity; and
the main body and the floating body move relative to each other under an action of waves, thereby driving the piston rod to reciprocate inside the cylinder barrel.

The above-mentioned multi-stage buffer hydraulic cylinder for the wave-energy power generation apparatus further includes an oil tank and an energy accumulator, wherein the main oil port sucks oil from the oil tank by means of a pipeline provided with a first check valve, the main oil port pumps hydraulic oil into the energy accumulator by means of a pipeline provided with a second check valve, and the rear oil port and the front oil port are communicated with the oil tank.

According to the above-mentioned multi-stage buffer hydraulic cylinder for the wave-energy power generation apparatus, further, a front buffer spring is installed on the inner wall close to the front end cover, and a rear buffer spring is installed on the inner wall close to the rear end cover.

According to the above-mentioned multi-stage buffer hydraulic cylinder for the wave-energy power generation apparatus, further, a first sealing ring is arranged between the piston rod and the front end cover; a second sealing ring is arranged between the main piston and the inner wall of the cylinder barrel; a third sealing ring is arranged between the outer wall of the built-in fixed rod and the main piston; and a fourth sealing ring is arranged between the auxiliary piston and the inner wall of the piston rod.

According to the above-mentioned multi-stage buffer hydraulic cylinder for the wave-energy power generation apparatus, further, the sealed cavity is filled with an inert gas

A multi-stage buffer hydraulic control method using the above-mentioned multi-stage buffer hydraulic cylinder for the wave-energy power generation apparatus includes:
a first control mode for use when the wave-absorbing floating body moves upward relative to the main body,
a second control mode for use when the wave-absorbing floating body moves downward relative to the main body,
a third control mode for use under an extreme wave condition in the first control mode; and
a fourth control mode for use under an extreme wave condition in the second control mode.

According to the above-mentioned multi-stage buffer hydraulic control method, further, the first control mode includes a control process as follows:
under the drive of waves, when the wave-absorbing floating body moves upward relative to the main body, the piston rod of the hydraulic cylinder also moves upward synchronously, the main rod-containing cavity of the hydraulic cylinder sucks oil from the oil tank by means of the front oil port, and the main cavity of the hydraulic cylinder discharges hydraulic oil into the oil tank by means of the rear oil port; the piston-rod inner cavity and the fixed-rod inner cavity are filled with the hydraulic oil, and when the piston rod moves upward, the hydraulic oil in the piston-rod inner cavity and in the fixed-rod inner cavity is squeezed, and then pumped into an energy accumulator set by means of the main oil port and the second check valve for energy accumulation and pressure stabilization and thus power generation; and in this process, a gas in the sealed cavity is in an expansion process.

According to the above-mentioned multi-stage buffer hydraulic control method, further, the second control mode includes a control process as follows:
under the action of waves, when the wave-absorbing floating body moves downward relative to the main body, the piston rod of the hydraulic cylinder also moves downward synchronously, the main rod-containing cavity of the hydraulic cylinder discharges hydraulic oil into the oil tank by means of the front oil port, and the main cavity of the hydraulic cylinder sucks oil from the oil tank by means of the rear oil port, when the piston rod moves downward, the piston-rod inner cavity and the fixed-rod inner cavity suck oil from the oil tank by means of the main oil port and the first check valve; and in this process, a gas in the sealed cavity is in a compression process.

According to the above-mentioned multi-stage buffer hydraulic control method, further, the third control mode includes a control process as follows:
under extreme waves, when the wave-absorbing floating body moves upward relative to the main body, the piston rod also moves upward synchronously; when the main piston moves to a certain distance from the rear end cover, the main piston begins to compress the rear buffer spring, and in a process of compressing the spring, mechanical energy of the wave-absorbing floating body is converted into potential energy of the spring to finally generate heat energy; and the main cavity sucks and discharges the hydraulic oil into the oil tank by means of the rear oil port to take away heat using the flowing hydraulic oil.

According to the above-mentioned multi-stage buffer hydraulic control method, further the fourth control mode includes a control process as follows:
under extreme waves, when the wave-absorbing floating body moves downward relative to the main body, the piston rod also moves downward synchronously; when the main piston moves to a certain distance from the front end cover, the main piston begins to compress the front buffer spring, and in a process of compressing the spring, mechanical energy of the wave-absorbing floating body is converted into potential energy of the spring to finally generate heat energy; and the main rod-containing cavity sucks and discharges the hydraulic oil into the oil tank by means of the front oil port to take away heat using the flowing hydraulic oil.

Compared with the prior art, the present invention has the following advantageous effects.
1. When the hydraulic cylinder of the present invention serves as a power conversion component of a wave energy apparatus, the hydraulic oil in a high-pressure part mainly flows through the fixed-rod inner cavity and the piston-rod inner cavity, with a sealing effect achieved by the fourth sealing ring between the auxiliary piston and the piston rod; the fourth sealing ring is completely arranged on the inner wall of the piston rod, and is isolated from the outside by means of the sealed cavity; and thus, the sealing ring is well protected, and the sealing performance of the hydraulic cylinder is improved.
2. The hydraulic cylinder of the present invention solves the problem with the diameter design of the piston rod in the case of doing work by compressing the cylinder; the effective work area of the hydraulic cylinder of the present invention is the cross-sectional area of the piston-rod inner cavity, and is equal to the cross-sectional area of the piston rod minus the cross-sectional area of a piston rod wall; and thus, the diameter of the piston rod can be increased by increasing the wall thickness of the piston rod, without increasing the effective work area of the hydraulic cylinder. An increase in the diameter of the piston rod effectively improves the rod compression stability of the piston rod of the hydraulic cylinder in the case of doing work by compressing the cylinder.
3. The front and rear end covers of the hydraulic cylinder of the present invention each are provided with a buffer spring, which can provide a buffer for the movement of the piston rod of the hydraulic cylinder in the case of large waves to prevent the piston rod from exceeding the limit of a movement stroke and effectively avoid damage to the hydraulic cylinder caused by the fact that the main piston strikes the front and rear end covers; and the heat energy generated by compressing the spring is cooled and discharged by the hydraulic oil flowing through the front and rear oil ports.

### BRIEF DESCRIPTION OF THE DRAWINGS

To describe the technical solutions in the embodiments of the present invention more clearly, the following briefly introduces the accompanying drawings required for use in the embodiments. Apparently, the accompanying drawings in the following description show merely some embodiments of the present application, and a person of ordinary skills in the art may still derive other drawings from these accompanying drawings without creative efforts.

FIG. 1 is an installation diagram of a hydraulic cylinder in a point-absorption type wave energy apparatus in the case of doing work by stretching;

FIG. 2 is an installation diagram of a hydraulic cylinder in a point-absorption type wave energy apparatus in the case of doing work by compressing a cylinder;

FIG. 3 is a schematic structural diagram of a multi-stage buffer hydraulic cylinder for a wave-energy power generation apparatus;

FIG. 4 is a schematic diagram of a multi-stage buffer hydraulic cylinder for a wave-energy power generation apparatus, with a piston rod upward;

FIG. 5 is a schematic diagram of a multi-stage buffer hydraulic cylinder for a wave-energy power generation apparatus, with a piston rod compressing upward a buffer spring;

FIG. 6 is a schematic diagram of a multi-stage buffer hydraulic cylinder for a wave-energy power generation apparatus, with a piston rod downward; and

FIG. 7 is a schematic diagram of a multi-stage buffer hydraulic cylinder for a wave-energy power generation apparatus, with a piston rod compressing downward a buffer spring.

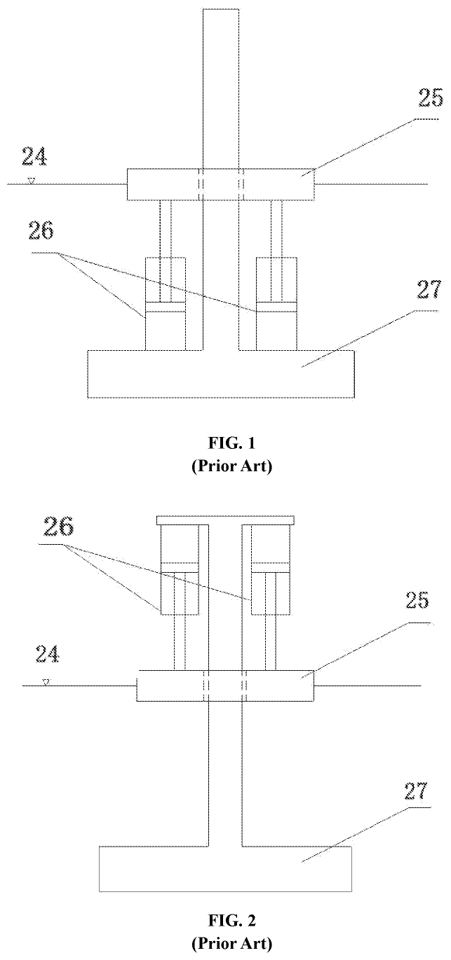

In the drawings, reference signs are as follows: 1, cylinder barrel; 2, rear end cover; 3, main oil port, 4, rear oil port; 5, front oil port, 6, first check valve; 7, second check valve; 8, front end cover; 9, piston rod: 10, main piston; 11, built-in fixed rod; 12, auxiliary piston; 13, front buffer spring; 14, rear buffer spring; 15, main rod-containing cavity; 16, main cavity: 17, piston-rod inner cavity; 18, fixed-rod inner cavity; 19, sealed cavity, 20, first sealing ring, 21, second sealing ring, 22, third sealing ring; and 23, fourth sealing ring: 24: Sea level; 25: Wave-absorbing floating body: 26: Hydraulic cylinder; 27: Main body; 28: Energy accumulator; 29: Oil suction port; 30: Oil suction port of oil tank.

### DETAILED DESCRIPTION OF THE EMBODIMENTS

The technical solutions in the embodiments of the present invention are described clearly and completely below in combination with the accompanying drawings for the embodiments of the present invention. Apparently, the described embodiments are only a part of embodiments of the present application, rather than all embodiments of the present disclosure. All other embodiments acquired by persons skilled in the art based on the embodiments of the present application without creative work shall fall within the scope of the present application. Embodiment

It should be noted that the terms “first”, “second” and the like in the description and claims as well as in the accompanying drawings of the present invention are used to distinguish similar objects, but are not necessarily used to describe a specific order or temporal order. It should be understood that data used in this way can be interchanged where appropriate, so that the embodiments of the present invention described herein can be practiced in a sequence other than those illustrated or described herein. In addition, the terms “including” and “having” and any variations thereof in the embodiments of the present invention are intended to mean non-exclusive inclusion; for example, a process, method, system, product or device that includes a series of steps or units is not necessarily limited to those explicitly listed, but may include other steps or units not explicitly listed or inherent to these processes, methods, products or devices

It should be understood that directional or positional relationships indicated by the terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counter-clockwise”, “axial”, “radial”, and “circumferential” are directional or positional relationships as shown in the drawings, are only for the purposes of the ease in describing the present invention and simplification of its descriptions, but not for indicating or implying that the specified apparatus or element has to be located in a specific direction, and structured and operated in a specific direction. Therefore, these directional or positional relationships should not be understood as limitations to the present invention.

In the descriptions of the present invention, the term “plurality” refers to at least two, such as two and three, unless otherwise specifically defined In addition, unless otherwise definitely specified and limited, the terms “mounted”, “connected”, and “connection” need to be broadly understood. For example, connection may be fixed connection, or detachable connection or integrated connection, or may be mechanical connection or electric connection, or may be direct connection, or indirect connection via an intermediate medium, or communication of inner parts of two elements. A person of ordinary skill in the art can understand the specific meaning of the above terms in the present invention in accordance with specific conditions.

In the present invention, unless otherwise definitely specified and limited, the first feature being provided “above” or “below” the second feature may mean that the first feature is in direct contact with the second feature, or indirectly in contact with the second feature via an intermediate medium. Moreover, the first feature being provided “over”, “above”, and “on” the second feature may mean that the first feature is provided directly above, or above and staggered from the second feature, or merely means that a level of the first feature is higher than that of the second feature. The first feature being provided “under”, “below”, and “beneath” the second feature may mean that the first feature is provided directly below, or below and staggered from the second feature, or merely means that a level of the first feature is lower than that of the second feature.

According to the present invention, a built-in fixed rod is arranged inside a hydraulic cylinder barrel and nested in a piston rod, and fixed-rod and piston-rod inner cavities are taken as high-pressure working cavities, such that the diameter of the piston rod can be increased while the effective work area is reduced, which ensures that the hydraulic cylinder can start under small waves, and the requirement for rod compression stability can also be met under the condition of doing work by compressing the cylinder. Furthermore, the front and rear end covers of the hydraulic cylinder each are provided with a buffer spring for buffering the strike caused by the excessive stroke of the piston rod under the extreme wave condition, and the hydraulic cylinder may be buffered under the condition of heavy waves by reasonably setting the stiffness of the spring, such that a main piston does not strike the front and rear end covers. In addition, four sealing rings are arranged in the hydraulic cylinder to largely prevent the sealing rings in the high-pressure working cavity from failure.

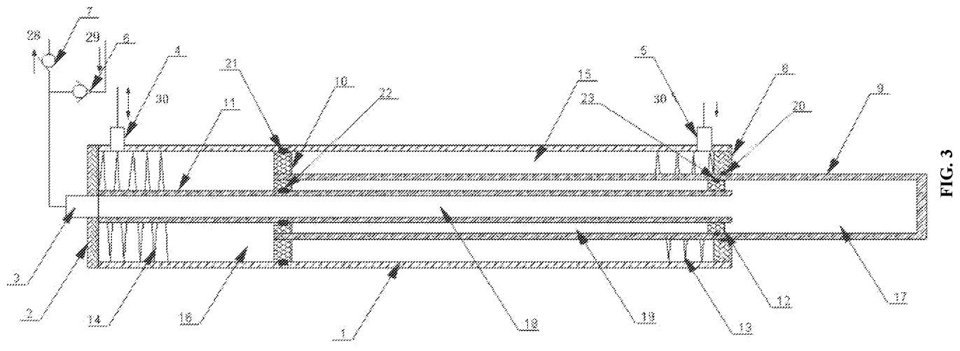

Referring to FIG. 3, it shows a schematic structural diagram of a multi-stage buffer hydraulic cylinder for a wave-energy power generation apparatus. The multi-stage buffer hydraulic cylinder includes a cylinder barrel 1; a rear end cover 2 is arranged at the rear part of the cylinder barrel; the rear end cover 2 and the cylinder barrel 1 may be connected via a bolt to facilitate disassembly and assembly; and the rear end cover 2 is provided with a main oil port 3. The main oil port 3 is communicated with a first check valve 6 and a second check valve 7, oil may be sucked from an oil tank by means of the first check valve 6; and the oil in the hydraulic cylinder may be pumped into an energy accumulator by means of the second check valve 7, thereby achieving the process of converting mechanical energy into hydraulic energy. The cylinder barrel 1 of the hydraulic cylinder is provided with a rear oil port 4 and a front oil port 5, and the rear oil port 4 and the front oil port 5 are directly communicated with the oil tank. The cylinder barrel 1 of the hydraulic cylinder is provided with a front end cover 8, which is connected with the cylinder barrel 1 via a bolt to facilitate disassembly and assembly.

Further, a hollow piston rod 9 is designed in the cylinder barrel 1 of the hydraulic cylinder; a left end of the piston rod 9 is installed with a main piston 10; the main piston 10 matches the inner wall of the cylinder barrel 1 and a second sealing ring 21 is arranged between the main piston 10 and the inner wall of the cylinder barrel 1; and the piston rod 9 may reciprocate along the cylinder barrel. A first sealing ring 20 is arranged between the piston rod 9 and the front end cover 8; a main rod-containing cavity 15 is defined by the piston rod 9, the main piston 10, the inner wall of the cylinder barrel 1 and the front end cover 8; and the hydraulic oil in the main rod-containing cavity 15 is sucked and discharged by means of the rear oil port 4.

Further, a front buffer spring 13 is installed on the inner wall of the front end cover 8, and is used to buffer the piston rod 9 under a bad wave condition to prevent the piston rod 9 from moving beyond a front limit position. A rear buffer spring 14 is further installed on the inner wall of the rear end cover 2, and is used to buffer the piston rod 9 under a bad wave condition to prevent the piston rod 9 from moving beyond a rear limit position.

Further, the inner wall of the rear end cover 2 is provided with a built-in fixed rod 11, and the outer wall of the built-in fixed rod 11 matches the main piston 10, and a third sealing ring 22 is arranged between the built-in fixed rod 11 and the main piston 10. The built-in fixed rod 11 is a hollow round rod, and has a fixed-rod inner cavity 18 provided therein. The built-in fixed rod 11 extends in length to the edge of the front end cover 8, the front end of the built-in fixed rod 11 is installed with an auxiliary piston 12, the auxiliary piston 12 matches the inner wall surface of the piston rod 9, and a fourth sealing ring 23 is installed between the auxiliary piston 12 and the inner wall surface of the piston rod 9. The auxiliary piston 12 divides a hollow inner cavity of the piston rod 9 into two parts, i.e., a piston-rod inner cavity 17 and a sealed cavity 19.

Further, the rear end of the built-in fixed rod 11 is communicated with the main oil port 3, such that the hydraulic oil in the fixed-rod inner cavity 18 may flow out and in from the rear end main oil port 3. The fixed-rod inner cavity 18 of the built-in fixed rod 11 is communicated with the piston-rod inner cavity 17, and when the hydraulic cylinder does work, the hydraulic oil of a high-pressure part mainly flows in the fixed-rod inner cavity 18 and the piston-rod inner cavity 17.

Further, nitrogen or an additional inert gas of an appropriate pressure may be filled into the sealed cavity 19 for protecting the fourth sealing ring 23.

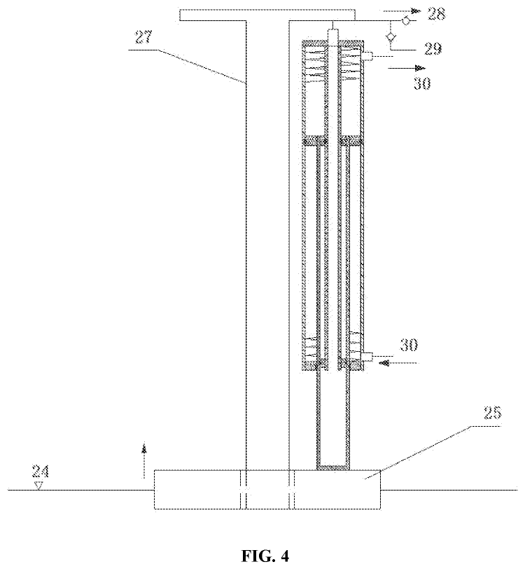

Referring to FIG. 4 to FIG. 7, they show the movement process of the multi-stage buffer hydraulic cylinder under different wave conditions.

The piston rod 9 of the hydraulic cylinder is connected to a wave-absorbing floating body of the wave-energy power generation apparatus, and the cylinder barrel 1 of the hydraulic cylinder is connected to a main body of the wave-energy power generation apparatus. Under the action of waves, the wave-absorbing floating body and the main body move relative to each other to drive the piston rod 9 to reciprocate in the cylinder barrel 1.

Under a normal wave condition, when the wave-absorbing floating body of the wave-energy power generation apparatus moves upward relative to the main body under the drive of waves, the piston rod 9 of the hydraulic cylinder also moves upward synchronously, as shown in FIG. 4. The main rod-containing cavity 15 of the hydraulic cylinder sucks oil from the oil tank by means of the front oil port 5, and a main cavity 16 of the hydraulic cylinder discharges the hydraulic oil into the oil tank by means of the rear oil port 4. The piston rod 9 is a round rod that is hollow inside, and the piston-rod inner cavity 17 is filled with hydraulic oil. The built-in fixed rod 11 is welded onto the rear end cover 2 of the cylinder barrel 1; the front end of the fixed-rod inner cavity 18 of the built-in fixed rod 11 is communicated with the piston-rod inner cavity 17; the rear cavity of the built-in fixed rod 11 is communicated with the main oil port 3; and during working, the fixed-rod inner cavity 18 is also filled with hydraulic oil. When the piston rod 9 moves upward, the hydraulic oil in the piston-rod inner cavity 17 and in the fixed-rod inner cavity 18 is squeezed, and is pumped into an energy accumulator set by means of the main oil port 3 and the second check valve for energy storage, pressure stabilization and thus power generation In this process, the gas in the sealed cavity 19 is in an expansion process. According to the design, under a normal wave condition, when the piston rod 9 moves upward, the piston rod generally does not move to the position of the rear buffer spring 14.

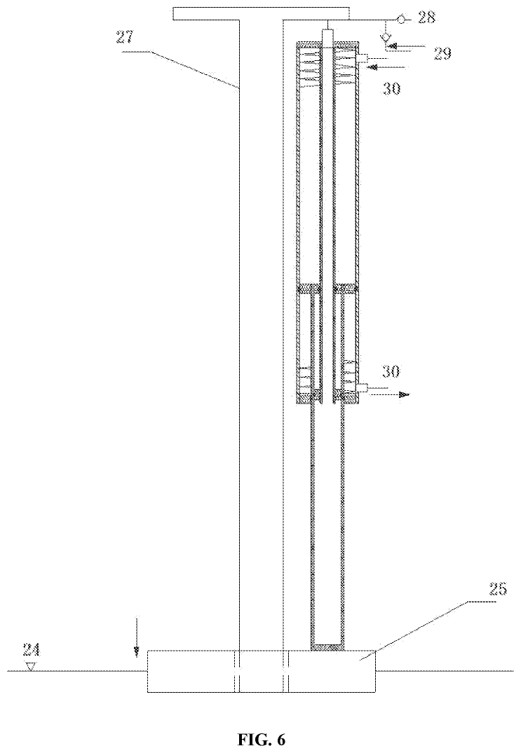

Under a normal wave condition, when the wave-absorbing floating body of the wave-energy power generation apparatus moves downward relative to the main body under the action of waves, the piston rod 9 of the hydraulic cylinder also moves downward synchronously, as shown in FIG. 6. The main rod-containing cavity 15 of the hydraulic cylinder discharges the hydraulic oil into the oil tank by means of the front oil port 5, and the main cavity 16 of the hydraulic cylinder sucks oil from the oil tank by means of the rear oil port 4. When the piston rod 9 moves downward, the piston-rod inner cavity 17 and the fixed-rod inner cavity 18 suck oil from the oil tank by means of the main oil port 3 and the first check valve. In this process, the gas in the sealed cavity 19 is in a compression process. According to the design, under a normal wave condition, when the piston rod 9 moves downward, the piston rod generally does not move to the position of the front buffer spring 13.

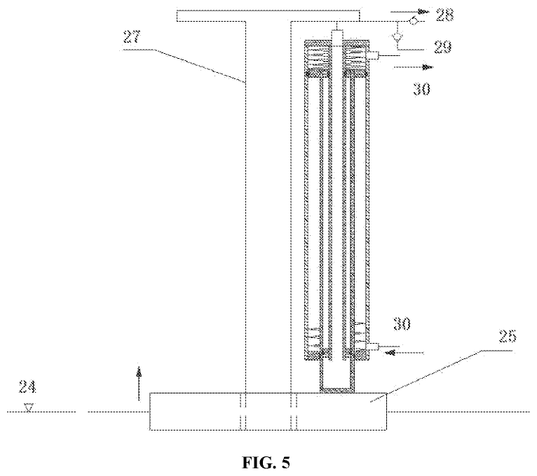

Under an extreme wave condition, when the wave-absorbing floating body of the wave-energy power generation apparatus moves upward relative to the main body under the drive of waves, the piston rod 9 also moves upward synchronously, as shown in FIG. 5. However, unlike those under the normal wave condition, the main piston 10 at the left end of the piston rod 9 in this case is driven by extreme heavy waves, and the wave force acting on the wave-absorbing floating body is very large, such that the main piston 10 may strike the rear end cover 2 of the hydraulic cylinder frequently, which would damage the hydraulic cylinder by the strike if no measure is taken. In order to buffer the strike to avoid damage, the rear buffer spring 14 is arranged on the rear end cover 2. When the main piston 10 moves to a certain distance from the rear end cover 2, the main piston 10 begins to compress the rear buffer spring 14. The stiffness of the rear buffer spring 14 is set according to the magnitude of extreme wave force, to ensure that the main piston 10 does not strike the rear end cover under the action of extreme waves. The whole process of compressing the spring is to convert the mechanical energy of the wave-absorbing floating body into the potential energy of the spring to finally generate the heat energy. In order to take away the heat generated in the buffering process, the main cavity 16 sucks and discharges the hydraulic oil into the low-pressure oil tank by means of the rear oil port 4 to take away the heat using the flowing hydraulic oil.

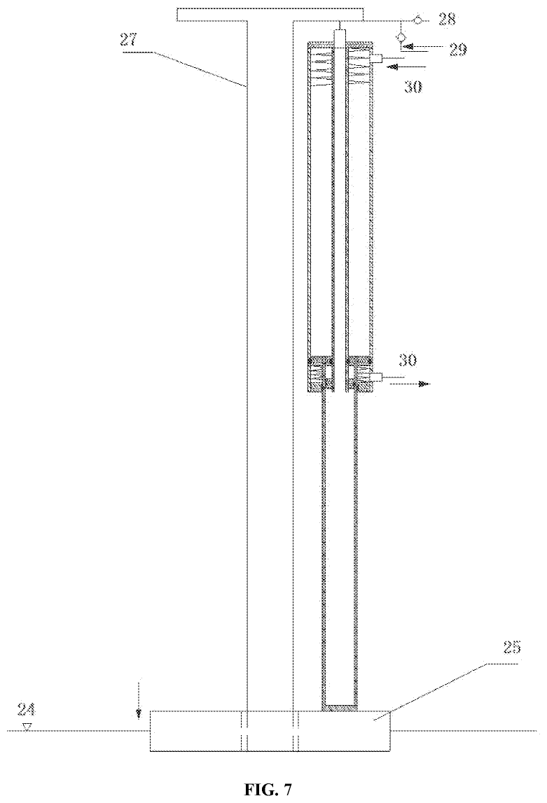

Under an extreme wave condition, when the wave-absorbing floating body of the wave-energy power generation apparatus moves downward relative to the main body under the action of waves, the piston rod 9 also moves downward synchronously, as shown in FIG. 7, and similarly, due to the action of extreme heavy waves, the main piston 10 may also strike the front end cover 8 of the hydraulic cylinder frequently. In order to buffer the extent of downward movement of the main piston 10, the front buffer spring 13 is also similarly arranged on the front end cover 8 of the hydraulic cylinder. When the main piston 10 moves to a certain distance from the front end cover 8, the main piston 10 begins to compress the front buffer spring 13. The stiffness of the front buffer spring 13 is set according to the magnitude of extreme wave force. In order to cool the heat generated in the process of buffering and compressing the spring, the main rod-containing cavity 15 sucks and discharges the hydraulic oil into the low-pressure oil tank by means of the front oil port 5 to take away the heat using the flowing hydraulic oil.

In the descriptions of the present description, the descriptions of referring terms such as “one embodiment”, “some embodiments”, “examples”, “specific examples” or “some examples” mean that specific features, structures, materials or characteristics described in combination with the embodiment or example are included in at least one embodiment or example of the present invention. In the present description, the schematic representation of the terms described above does not necessarily refer to the same embodiment or example. Furthermore, the described particular features, structures, materials, or characteristics may be combined in any suitable manner in any one or more embodiments or examples. In addition, different embodiments or examples described in the present description, as well as features of different embodiments or examples, may be integrated and combined so long as they do not conflict with each other.

The above-mentioned embodiments are merely for explaining the technical concept and features of the present invention, and are intended to enable those of ordinary skill in the art to understand the contents of the present invention and to implement them accordingly. Thus, the above embodiments are not intended to limit the scope of protection of the present invention. All equivalent changes or modifications made in accordance with the essence of the present invention should be covered by the scope of protection of the present invention.

What is claimed is:

1. A multi-stage buffer hydraulic cylinder for a wave-energy power generation apparatus, wherein the multi-stage buffer hydraulic cylinder is used to be connected to the wave-energy power generation apparatus, the wave-energy power generation apparatus comprises a main body and a wave-absorbing floating body, and the multi-stage buffer hydraulic cylinder comprises:
a cylinder barrel provided with a rear end cover and a front end cover at both ends, the cylinder barrel being connected to the main body;
a built-in fixed rod coaxially arranged in the cylinder barrel, the built-in fixed rod having a hollow cavity, and a right end of the built-in fixed rod extending to the front end cover and being installed with an auxiliary piston; and
a piston rod coaxially sleeving the built-in fixed rod, the piston rod having a hollow cavity, a left end of the piston rod being installed with a main piston, a right end of the piston rod being connected to the wave-absorbing floating body, and the cylinder barrel, the piston rod, and the built-in fixed rod forming a multi-stage cylinder, wherein
the hollow cavity of the built-in fixed rod is a fixed-rod inner cavity, and a left end of the fixed-rod inner cavity is communicated with a main oil port; a cavity defined by an outer wall of the built-in fixed rod, an inner wall of the piston rod, the main piston, and the auxiliary piston is a sealed cavity; the hollow cavity of the piston rod excluding a portion forming the sealed cavity is a piston-rod inner cavity; a cavity defined by an inner wall of the cylinder barrel, the rear end cover, the outer wall of the built-in fixed rod, and the main piston is a main cavity, the main cavity is communicated with a rear oil port; a cavity defined by the inner wall of the cylinder barrel, the front end cover, an outer wall of the piston rod, and the main piston is a main rod-containing cavity, the main rod-containing cavity is communicated with a front oil port; the fixed-rod inner cavity is communicated with the piston-rod inner cavity; and
the main body and the wave-absorbing floating body move relative to each other under an action of waves, thereby driving the piston rod to reciprocate inside the cylinder barrel.

2. The multi-stage buffer hydraulic cylinder for the wave-energy power generation apparatus according to claim 1, further comprising an oil tank and an energy accumulator, wherein the main oil port sucks oil from the oil tank by a pipeline provided with a first check valve, the main oil port pumps hydraulic oil into the energy accumulator by a pipeline provided with a second check valve, and the rear oil port and the front oil port are communicated with the oil tank.

3. The multi-stage buffer hydraulic cylinder for the wave-energy power generation apparatus according to claim 1, wherein a front buffer spring is installed on an inner wall close to the front end cover, and a rear buffer spring is installed on an inner wall close to the rear end cover.

4. The multi-stage buffer hydraulic cylinder for the wave-energy power generation apparatus according to claim 1, wherein a first sealing ring is arranged between the piston rod and the front end cover; a second sealing ring is arranged between the main piston and the inner wall of the cylinder barrel; a third sealing ring is arranged between the outer wall of the built-in fixed rod and the main piston; and a fourth sealing ring is arranged between the auxiliary piston and the inner wall of the piston rod.

5. The multi-stage buffer hydraulic cylinder for the wave-energy power generation apparatus according to claim 1, wherein the sealed cavity is filled with an inert gas.

6. A multi-stage buffer hydraulic control method using the multi-stage buffer hydraulic cylinder for the wave-energy power generation apparatus according to claim 1, comprising:
a first control mode for use when the wave-absorbing floating body moves upward relative to the main body,
a second control mode for use when the wave-absorbing floating body moves downward relative to the main body,
a third control mode for use under an extreme wave condition in the first control mode; and
a fourth control mode for use under an extreme wave condition in the second control mode.

7. The multi-stage buffer hydraulic control method according to claim 6, wherein the first control mode comprises a control process as follows:
under a drive of waves, when the wave-absorbing floating body moves upward relative to the main body, the piston rod of the multi-stage buffer hydraulic cylinder also moves upward synchronously, the main rod-containing cavity of the multi-stage buffer hydraulic cylinder sucks oil from an oil tank by the front oil port, and the main cavity of the multi-stage buffer hydraulic cylinder discharges hydraulic oil into the oil tank by the rear oil port; the piston-rod inner cavity and the fixed-rod inner cavity are filled with the hydraulic oil, and when the piston rod moves upward, the hydraulic oil in the piston-rod inner cavity and in the fixed-rod inner cavity is squeezed, and then pumped into an energy accumulator set by the main oil port and a second check valve for energy accumulation and pressure stabilization and thus power generation; and in this process, a gas in the sealed cavity is in an expansion process.

8. The multi-stage buffer hydraulic control method according to claim 6, wherein the second control mode comprises a control process as follows:
under an action of waves, when the wave-absorbing floating body moves downward relative to the main body, the piston rod of the multi-stage buffer hydraulic cylinder also moves downward synchronously, the main rod-containing cavity of the multi-stage buffer hydraulic cylinder discharges hydraulic oil into an oil tank by the front oil port, and the main cavity of the multi-stage buffer hydraulic cylinder sucks oil from the oil tank by the rear oil port; when the piston rod moves downward, the piston-rod inner cavity and the fixed-rod inner cavity suck the oil from the oil tank by the main oil port and a first check valve; and in this process, a gas in the sealed cavity is in a compression process.

9. The multi-stage buffer hydraulic control method according to claim 6, wherein the third control mode comprises a control process as follows:
under extreme waves, when the wave-absorbing floating body moves upward relative to the main body, the piston rod also moves upward synchronously; when the main piston moves to a predetermined distance from the rear end cover, the main piston begins to compress a rear buffer spring, and in a process of compressing the rear buffer spring, mechanical energy of the wave-absorbing floating body is converted into potential energy of the rear buffer spring to finally generate heat energy; and the main cavity sucks and discharges hydraulic oil into an oil tank by the rear oil port to take away heat using a flow of the hydraulic oil.

10. The multi-stage buffer hydraulic control method according to claim 6, wherein the fourth control mode comprises a control process as follows:
under extreme waves, when the wave-absorbing floating body moves downward relative to the main body, the piston rod also moves downward synchronously; when the main piston moves to a predetermined distance from the front end cover, the main piston begins to compress a front buffer spring, and in a process of compressing the front buffer spring, mechanical energy of the wave-absorbing floating body is converted into potential energy of the front buffer spring to finally generate heat energy; and the main rod-containing cavity sucks and discharges hydraulic oil into an oil tank by the front oil port to take away heat using a flow of the hydraulic oil.

11. A multi-stage buffer hydraulic control method using the multi-stage buffer hydraulic cylinder for the wave-energy power generation apparatus according to claim 2, comprising:
a first control mode for use when the wave-absorbing floating body moves upward relative to the main body,
a second control mode for use when the wave-absorbing floating body moves downward relative to the main body,
a third control mode for use under an extreme wave condition in the first control mode; and
a fourth control mode for use under an extreme wave condition in the second control mode.

12. A multi-stage buffer hydraulic control method using the multi-stage buffer hydraulic cylinder for the wave-energy power generation apparatus according claim 3, comprising:
a first control mode for use when the wave-absorbing floating body moves upward relative to the main body,
a second control mode for use when the wave-absorbing floating body moves downward relative to the main body,
a third control mode for use under an extreme wave condition in the first control mode; and
a fourth control mode for use under an extreme wave condition in the second control mode.

13. A multi-stage buffer hydraulic control method using the multi-stage buffer hydraulic cylinder for the wave-energy power generation apparatus according to claim 4, comprising:
a first control mode for use when the wave-absorbing floating body moves upward relative to the main body,
a second control mode for use when the wave-absorbing floating body moves downward relative to the main body,
a third control mode for use under an extreme wave condition in the first control mode; and
a fourth control mode for use under an extreme wave condition in the second control mode.

14. A multi-stage buffer hydraulic control method using the multi-stage buffer hydraulic cylinder for the wave-energy power generation apparatus according to claim 5, comprising:
a first control mode for use when the wave-absorbing floating body moves upward relative to the main body,
a second control mode for use when the wave-absorbing floating body moves downward relative to the main body,
a third control mode for use under an extreme wave condition in the first control mode; and
a fourth control mode for use under an extreme wave condition in the second control mode.

15. The multi-stage buffer hydraulic control method according to claim 11, wherein the first control mode comprises a control process as follows:
under a drive of waves, when the wave-absorbing floating body moves upward relative to the main body, the piston rod of the multi-stage buffer hydraulic cylinder also moves upward synchronously, the main rod-containing cavity of the multi-stage buffer hydraulic cylinder sucks the oil from the oil tank by the front oil port, and the main cavity of the multi-stage buffer hydraulic cylinder discharges the hydraulic oil into the oil tank by the rear oil port; the piston-rod inner cavity and the fixed-rod inner cavity are filled with the hydraulic oil, and when the piston rod moves upward, the hydraulic oil in the piston-rod inner cavity and in the fixed-rod inner cavity is squeezed, and then pumped into an energy accumulator set by the main oil port and the second check valve for energy accumulation and pressure stabilization and thus power generation; and in this process, a gas in the sealed cavity is in an expansion process.

16. The multi-stage buffer hydraulic control method according to claim 11, wherein the second control mode comprises a control process as follows:
under an action of waves, when the wave-absorbing floating body moves downward relative to the main body, the piston rod of the multi-stage buffer hydraulic cylinder also moves downward synchronously, the main rod-containing cavity of the multi-stage buffer hydraulic cylinder discharges the hydraulic oil into the oil tank by the front oil port, and the main cavity of the multi-stage buffer hydraulic cylinder sucks the oil from the oil tank by the rear oil port; when the piston rod moves downward, the piston-rod inner cavity and the fixed-rod inner cavity suck the oil from the oil tank by the main oil port and the first check valve; and in this process, a gas in the sealed cavity is in a compression process.

17. The multi-stage buffer hydraulic control method according to claim 11, wherein the third control mode comprises a control process as follows:
under extreme waves, when the wave-absorbing floating body moves upward relative to the main body, the piston rod also moves upward synchronously; when the main piston moves to a predetermined distance from the rear end cover, the main piston begins to compress a rear buffer spring, and in a process of compressing the buffer spring spring, mechanical energy of the wave-absorbing floating body is converted into potential energy of the buffer spring spring to finally generate heat energy; and the main cavity sucks and discharges the hydraulic oil into the oil tank by the rear oil port to take away heat using a flow of the hydraulic oil.

18. The multi-stage buffer hydraulic control method according to claim 11, wherein the fourth control mode comprises a control process as follows:
under extreme waves, when the wave-absorbing floating body moves downward relative to the main body, the piston rod also moves downward synchronously; when the main piston moves to a predetermined distance from the front end cover, the main piston begins to compress a front buffer spring, and in a process of compressing the front buffer spring, mechanical energy of the wave-absorbing floating body is converted into potential energy of the front buffer spring to finally generate heat energy; and the main rod-containing cavity sucks and discharges the hydraulic oil into the oil tank by the front oil port to take away heat using flowing flow of the hydraulic oil.

19. The multi-stage buffer hydraulic control method according to claim 12, wherein the first control mode comprises a control process as follows:
under a drive of waves, when the wave-absorbing floating body moves upward relative to the main body, the piston rod of the multi-stage buffer hydraulic cylinder also moves upward synchronously, the main rod-containing cavity of the multi-stage buffer hydraulic cylinder sucks oil from an oil tank by the front oil port, and the main cavity of the multi-stage buffer hydraulic cylinder discharges hydraulic oil into the oil tank by the rear oil port; the piston-rod inner cavity and the fixed-rod inner cavity are filled with the hydraulic oil, and when the piston rod moves upward, the hydraulic oil in the piston-rod inner cavity and in the fixed-rod inner cavity is squeezed, and then pumped into an energy accumulator set by the main oil port and a second check valve for energy accumulation and pressure stabilization and thus power generation; and in this process, a gas in the sealed cavity is in an expansion process.

20. The multi-stage buffer hydraulic control method according to claim 12, wherein the second control mode comprises a control process as follows:
under an action of waves, when the wave-absorbing floating body moves downward relative to the main body, the piston rod of the multi-stage buffer hydraulic cylinder also moves downward synchronously, the main rod-containing cavity of the multi-stage buffer hydraulic cylinder discharges hydraulic oil into an oil tank by the front oil port, and the main cavity of the multi-stage buffer hydraulic cylinder sucks oil from the oil tank by the rear oil port; when the piston rod moves downward, the piston-rod inner cavity and the fixed-rod inner cavity suck the oil from the oil tank by the main oil port and a first check valve; and in this process, a gas in the sealed cavity is in a compression process.
